(19) United States
(12) Patent Application Publication
(10) Pub. No.: US 2022/0067379 A1
(43) Pub. Date: Mar. 3, 2022

(54) CATEGORY LABELLING METHOD AND DEVICE, AND STORAGE MEDIUM

(71) Applicant: SHENZHEN SENSETIME TECHNOLOGY CO., LTD., Shenzhen (CN)

(72) Inventors: Yingzhen CHEN, Shenzhen (CN); Ze ZHANG, Shenzhen (CN); Qi FANG, Shenzhen (CN); Danting CHEN, Shenzhen (CN); Huan PEI, Shenzhen (CN)

(21) Appl. No.: 17/521,798

(22) Filed: Nov. 8, 2021

Related U.S. Application Data
(63) Continuation of application No. PCT/CN2020/092694, filed on May 27, 2020.

(30) Foreign Application Priority Data
Jan. 19, 2020 (CN) 202010060050.4

(51) Int. Cl. G06K 9/00

(52) U.S. Cl. CPC G06K 9/00671; G06K 9/00684; G06K 9/00718

(57) ABSTRACT

The present disclosure relates to a category labelling method and apparatus, an electronic device, a storage medium, and a computer program. The method includes: detecting a video stream acquired by an image acquisition device to determine a detection result of a target video frame in the video stream, wherein the detection result includes a detected category, and the detected category includes at least one of: an object category of an object in the target video frame, and a scene category corresponding to the target video frame; and determining a category labelling result corresponding to the image acquisition device according to detection results of a plurality of target video frames.

### CROSS-REFERENCE TO RELATED APPLICATION

This application a continuation of and claims the priority under 35 U.S.C. § 120 to PCT Application No. PCT/CN2020/092694, filed on May 27, 2020, which claims the priority of Chinese Patent Application No. 202010060050.4, filed on Jan. 19, 2020, with the CNIPA, of which the title is “Category labelling Method and Apparatus, Electronic Device, and Storage Medium”. All the above referenced priority documents are incorporated herein by reference in their entireties.

### TECHNICAL FIELD

The present disclosure relates to the field of computer technologies, and in particular, to a category labelling method and apparatus, an electronic device, a storage medium, and a computer program.

### BACKGROUND

With the development of science and technology, image acquisition devices have been used in all aspects of industrial production and life. For example, video monitoring systems have been widely popularized as an important part of social public safety. Many enterprises and institutions have now built a large number of video monitoring systems, which often include a large number of image acquisition devices.

### SUMMARY

The present disclosure provides a technical solution of category labelling.

According to an aspect of the present disclosure, there is provided a category labelling method, including:

detecting a video stream acquired by an image acquisition device to determine a detection result of a target video frame in the video stream, wherein the detection result includes a detected category, and the detected category includes at least one of: an object category of an object in the target video frame, and a scene category corresponding to the target video frame; and

determining a category labelling result corresponding to the image acquisition device according to detection results of a plurality of target video frames.

According to an aspect of the present disclosure, there is provided a category labelling device, including: a processor; and a memory, configured to store processor-executable instructions, wherein the processor is configured to execute the instructions stored in the memory, to perform the foregoing method.

According to an aspect of the present disclosure, there is provided a non-transitory computer readable storage medium, having computer program instructions stored thereon, the computer program instructions, when executed by a processor, cause the processor to implement the foregoing method.

In embodiments of the present disclosure, the category labelling result of the image acquisition device can be accurately determined, to implement category division on the image acquisition devices.

It will be appreciated that the foregoing general descriptions and the following detailed descriptions are merely for exemplary and explanatory purposes, and are not intended to limit the present disclosure. According to the following detailed descriptions of exemplary embodiments with reference to the accompanying drawings, other features and aspects of the present disclosure will become clear.

### BRIEF DESCRIPTION OF THE DRAWINGS

The accompanying drawings herein, which are incorporated into the specification as a part of the specification, show embodiments in accordance with the present disclosure, and together with the specification are used to explain the technical solutions of the present disclosure.

FIG. 1 is a flowchart of a category labelling method according to an embodiment of the present disclosure.

FIG. 2 is a block diagram of a category labelling apparatus according to an embodiment of the present disclosure.

FIG. 3 is a block diagram of an electronic device according to an embodiment of the present disclosure.

FIG. 4 is a block diagram of an electronic device according to an embodiment of the present disclosure.

### DETAILED DESCRIPTION

Various exemplary embodiments, features, and aspects of the present disclosure will be described in detail below with reference to the accompanying drawings. Same reference numerals in the drawings represent same or similar components. Although various aspects of the embodiments are shown in the drawings, the drawings are not necessarily drawn to scale unless otherwise specified.

The dedicated word “exemplary” herein means “serving as an example, embodiment, or illustration”. Any embodiment described herein as “exemplary” need not be construed as being superior or better than other embodiments.

The term “and/or” in this specification is only an association relationship for describing associated objects, and represents that three relationships may exist, for example, A and/or B may represent the following three cases: A exists alone, both A and B exist, and B exists alone. In addition, the term “at least one” herein means any one of a plurality of or any combination of at least two of the plurality, for example, “including at least one of A, B, and C” may mean including any one or more elements selected from a set consisting of A, B, and C.

In addition, in order to better explain the present disclosure, numerous specific details are provided in the following detailed description. Those skilled in the art will appreciate that the present disclosure may also be implemented without certain specific details. In some examples, the methods, means, elements, and circuits well-known to those skilled in the art are not described in detail, to highlight the gist of the present disclosure.

With the development of science and technology, image acquisition devices have been spread across all aspects of industrial production and life. Image acquisition devices can be seen everywhere on the street. In some monitoring systems, there are dozens or even tens of thousands of image acquisition devices that need to be managed. The large number of image acquisition devices makes the management of image acquisition devices increasingly difficult.

According to the category labelling method provided in the embodiments of the present disclosure, the category labelling result of the image acquisition device can be accurately determined, to implement category division on the image acquisition devices, so as to facilitate an administrator in managing and calling the image acquisition device through the dimension of the category, thereby reducing the difficulty in managing the image acquisition device.

The category labelling method provided in the embodiments of the present disclosure may be applied to labelling of categories of image acquisition devices, and the application value thereof may be reflected at least from the following aspects:

(1) The efficiency of operating, maintaining, and using an image acquisition device can be improved. When a user may want to view some required monitoring images through the image acquisition device, a quick response to the user's request can be realized without viewing the images of the image acquisition device one by one by the user. For example, when the police may want to search for image acquisition devices that can capture human faces for tracking a criminal suspect, it will take a lot of time to manually search from hundreds or even tens of thousands of image acquisition devices. According to the category labelling method provided in the embodiments of the present disclosure, the police users can search for the image acquisition devices through the dimension of the category because the image acquisition devices are labelled with categories, which will greatly improve the efficiency of search.

(2) The efficiency and accuracy of category labelling of the image acquisition device can be improved. It will greatly save manpower, material resources, and time to automatically extract video frames for detection and classify image acquisition devices compared to manually viewing the images acquired by each video acquisition device for analysis. At the same time, because the classification process may not be interfered by personal factors and the category may be obtained according to the detection results of a plurality of target video frames, the accuracy of the classification of the image acquisition device can be improved.

An execution body of the category labelling method provided in the embodiments of the present disclosure may be a category labelling apparatus. For example, the category labelling method may be performed by a terminal device or a server or another processing device. The terminal device may be user equipment (UE), a mobile device, a user terminal, a terminal, a cellular phone, a cordless phone, a personal digital assistant (PDA), a handheld device, a computing device, a vehicle-mounted device, a wearable device, or the like. In some possible implementations, the category labelling method may be implemented by executing, by a processor, computer readable instructions stored in a memory.

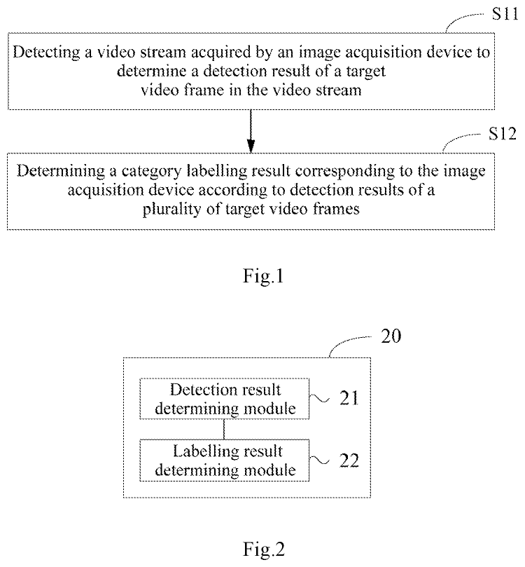

FIG. 1 is a flowchart of a category labelling method according to an embodiment of the present disclosure. As shown in FIG. 1, the category labelling method includes:

Step S11: detecting a video stream acquired by an image acquisition device to determine a detection result of a target video frame in the video stream.

The detection result includes a detected category, and the detected category includes at least one of: an object category of an object in the target video frame, and a scene category corresponding to the target video frame.

The image acquisition device has an image acquisition function, and can send acquired images in the form of a video stream, and the video stream for detection may be acquired by the image acquisition device in real time.

During detection, the video frame in the video stream may be detected. The specific representation form of the video frame may be an image, and therefore, the video frame may also be referred to as an image frame. For ease of description, the video frame to be detected herein is referred to as a target video frame.

Step S12: determining a category labelling result corresponding to the image acquisition device according to detection results of a plurality of target video frames.

When the category labelling result corresponding to the image acquisition device is determined, in order to improve the accuracy of the category labelling result, the category labelling result may be determined according to the detection results of a plurality of target video frames.

According to the embodiments of the present disclosure, the detection result of the target video frame in the video stream can be determined by detecting the video stream acquired by the image acquisition device, where the detection result includes the detected category, and the detected category includes at least one of: the object category of the object in the target video frame, and the scene category corresponding to the target video frame. The category labelling result corresponding to the image acquisition device can then be determined according to the detection results of the plurality of target video frames. A category of a video frame acquired by the image acquisition device can be determined by detecting the video frame. A category labelling result of the image acquisition device can be accurately determined according to the categories of a plurality of video frames category labelling, thereby realizing category division of the image acquisition devices. This can facilitate an administrator in managing and calling the image acquisition device through the dimension of the category, thereby reducing the difficulty in managing the image acquisition device. In addition, it will greatly save manpower, material resources, and time to automatically extract video frames for detection and classify image acquisition devices compared to manually viewing, from a video convergence platform, the video stream acquired by each image acquisition device for analysis. At the same time, because the classification process may not be interfered by personal factors, the accuracy of the classification of the image acquisition device can be improved.

In a possible implementation, the target video frame may be classified through detection of the target video frame, to obtain the category of the target video frame. When the target video frame is classified through detection of the target video frame, an object category of the object in the target video frame may be determined according to the object included in the target video frame, or a scene category corresponding to the target video frame may be obtained according to a scene of the target video frame.

The object included in the target video frame may be obtained by parsing the target video frame. During specific parsing of the target video frame, the object in the video frame may be recognized through a neural network. For example, the neural network may be used for face recognition to identify whether the target video frame includes a face, and the neural network may be used for vehicle recognition to identify whether the target video frame includes a vehicle, and the like.

The scene corresponding to the target video frame may also be obtained by parsing the target video frame through the neural network. The neural network may be trained through a sample picture labelled with a scene, and the trained neural network can recognize the scene of the target video frame.

In a possible implementation, before the detecting the video stream acquired by the image acquisition device, the method further includes: determining whether current time is night time; and in response to determining that the current time is not night time, detecting the video stream acquired by the image acquisition device. Then, in response to determining that the current time is the night time, the video stream acquired by the image acquisition device may not be detected.

The specific night time may be preset by the user. For example, the night time may be set to a period from 18:00 every day to 5:30 the next day. Alternatively, the night time may also be determined according to sunrise time and sunset time of the day at a position in which the image acquisition device is located. The night time may refer to a period after the sunset time and before the sunrise time. Then, when it is determined whether the current time is the night time, the sunrise time and sunset time of the position at which the image acquisition device is located can be obtained, and it can be determined according to the sunrise time and sunset time whether the current time is the night time.

The specific method for obtaining the sunrise time and sunset time may be performed via a network port that provides the sunrise time and sunset time, and the present disclosure does not specifically limit the specific obtaining method.

Considering that the definition of images acquired at night may not be high, it may result in inaccurate recognition of objects and scenes. Therefore, in a case that it is determined that the current time is not the night time, the video stream acquired by the image acquisition device may be detected, and in a case that it is determined that the current time is the night time, the video stream acquired by the image acquisition device may not be detected. This reduces a waste of processing resources and improves the accuracy of the category labelling results.

In a possible implementation, the object category includes at least one of: a face, a human body, a license plate, or a vehicle model; and the scene category includes at least one of: high altitude, low-altitude indoor, or low-altitude outdoor.

In a possible implementation, detecting the video stream acquired by the image acquisition device to determine the detection result of the target video frame in the video stream includes: determining a confidence of each of a plurality of categories corresponding to the target video frame; and in a case that there is a confidence greater than a confidence threshold, determining a category of the confidence greater than the confidence threshold as the detection result of the target video frame.

The confidence of each of the plurality of categories corresponding to the target video frame may be determined through a classification network. Specifically, the classification network may be a Visual Geometry Group Net (VGG Net), or a Residual Neural Network (ResNet). Which classification network is actually used may be determined according to actual application requirements of the present disclosure, which is not specifically limited in the present disclosure.

In some classification networks, the confidence may characterize a probability that the target video frame belongs to a particular category, or the confidence may be used to characterize a level that the target video frame belongs to a particular category. The higher the confidence is, the more probable that the target video frame belongs to the particular category. After the target video frame is provided as an input to the classification network, the confidence of each of a plurality of categories corresponding to the target video frame can be determined, and each category corresponds to one confidence.

The higher the confidence is, the higher the probability that the target video frame belongs to a particular category is. Therefore, a confidence threshold may be set, and a category corresponding to a confidence greater than the confidence threshold is determined as a detection result of the target video frame. There may be more than one confidence values greater than the confidence threshold, and then the target video frame corresponds to a plurality of categories. If there is no confidence greater than the confidence threshold, it may be determined that the target video frame does not belong to any category in the classification network, that is, no detection result of the target video frame may be obtained. For example, if the preset confidence threshold is 60%, a confidence of a category 1 output by the classification network 1 is 70%, a confidence of a category 2 is 20%, and a confidence of a category 3 is 10%, and then the category 1 may be determined as the detection result of the target video frame.

It should be noted that a specific value of the confidence threshold may be determined according to actual application requirements of the present disclosure, which is not specifically limited in the present disclosure.

The classification network may be trained through image sample data annotated with categories. For example, the classification network may be trained through sample pictures annotated with object categories such as a face, a human body, a license plate, a vehicle model and the like, and the trained network may be used for recognizing a category of an object. The classification network can be trained through sample pictures annotated with scene categories such as high altitude, low-altitude indoor, and low-altitude outdoor, and the trained network may be used for recognizing the foregoing scene categories. The specific training process is not described in detail herein.

In a possible implementation, to improve the accuracy of the category labelling result, after the detection result of the target video frame in the video stream is determined, a total number of detection results obtained in a preset time interval may also be determined, and in a case that the total number of the detection results is greater than a number threshold, a category labelling result corresponding to an image acquisition device may be determined according to the detection results of the plurality of target video frames.

It should be noted that, the larger the number threshold is, the higher the reliability of the obtained category labelling result is. However, to ensure the efficiency of determining the category labelling result, the number threshold cannot be excessively large. Therefore, the specific value of the number threshold may be determined according to actual application requirements of the present disclosure, which is not specifically limited in the present disclosure.

After the detection result of the target video frame in the video stream is determined, the total number of the detection results obtained in the preset time interval can be determined. When the total number of the detection results obtained in the preset time interval is determined herein, 1 may be added to the total number once a detection result of one target video frame is obtained, that is, a detection result of one target video frame corresponds to 1 in number. Alternatively, the specific obtained category number may be added to the total number after the detection result of one target video frame is obtained. That is, if the detection result of a target video frame includes n categories, n in number is correspondingly added. For example, if the detection result of a target video frame has 2 categories, two is added to the total number. The specific manner of determining the total number may be determined according to actual application requirements of the present disclosure, which is not specifically limited in the present disclosure.

The preset time interval may be set by the user, and the preset time interval may be a continuous time interval, or a plurality of discontinuous time intervals. In addition, the user may set time intervals between a plurality of preset time intervals. The setting of the specific preset time interval may be determined according to actual application requirements of the present disclosure, which is not specifically limited in the present disclosure.

According to the embodiments of the present disclosure, in a case that the total number of the detection results is greater than the number threshold, the category labelling result corresponding to the image acquisition device can be determined according to the detection results of the plurality of target video frames, so that the accuracy of the category labelling result can be improved.

In a possible implementation, to further improve the accuracy of the category labelling result, the determining the category labelling result corresponding to the image acquisition device according to the detection results of the plurality of target video frames includes: determining a ratio of a number of one or more detection categories in the plurality of detection results to the total number; and determining a detected category corresponding to a ratio greater than a ratio threshold as the category labelling result corresponding to the image acquisition device. The specific value of the ratio threshold may be determined according to actual application requirements of the present disclosure, which is not specifically limited in the present disclosure.

For example, for a video stream of a certain image acquisition device, if a total number of the obtained detection results is 100, where the number of face categories is 50, the number of body categories is 40, and the number of license plate categories is 10, and then the obtained ratio of the face categories is 50%, the ratio of the body categories is 40%, and the radio of the license plate categories is 10%. If the ratio threshold is set to 30%, the face category and the body category are the category labelling result corresponding to the image acquisition device.

In a possible implementation, after the category labelling result corresponding to the image acquisition device is determined, the category labelling result may be stored, to facilitate subsequently operating, maintaining, and calling the image acquisition device according to the category labelling result.

In a possible implementation, after the category labelling result corresponding to the image acquisition device is determined, the method further includes: in response to receiving a search request for an image acquisition device of a target category, returning the image acquisition device of the target category based on the determined category labelling result corresponding to the image acquisition device.

The search request for the image acquisition device of the target category may be triggered by a user through a human-machine interaction interface, which may present a category of the image acquisition device, for selection by the user. For ease of description, the category that the user requests to search for may be referred to as the target category herein.

After the search request is received, since the category labelling result of the image acquisition device has been pre-stored, the image acquisition device of the target category may be determined based on the determined category labelling result corresponding to the image acquisition device, and the determined image acquisition device of the target category can be returned to the user.

For example, if the use requests to call an image acquisition device that can see a face, the image acquisition devices can be filtered according to pre-annotated categories. After the request for searching for the image acquisition device of the face category is received, the image acquisition device of the face category may be searched for in a database and then returned to the user.

The embodiments according to the present disclosure may be applied, to improve the efficiency of operating, maintaining, and using the image acquisition device. For example, video monitoring means has become an important means for the police to investigate and solve cases. In the public security system, when a monitoring system for monitoring an object and/or a scene of a target category is built, the total built image acquisition devices may be analyzed through the category labelling method in the embodiments of the present disclosure, to obtain the category labelling result of the image acquisition device. Then, the user may select the image acquisition device of the object and/or scene of the target category, and add the image acquisition device to the monitoring system. In this way, efficient operation, maintenance, and use of the image acquisition device can be implemented.

The embodiments according to the present disclosure may also be applied to the investigation analysis of the image acquisition device. Through the embodiments of the present disclosure, the scene type in the monitored image and an object suitable for parsing may be investigated for analysis, to improve the investigation efficiency and the unity of the category of the image acquisition device.

It may be understood that, without violating the principle and logic, the foregoing method embodiments mentioned in the present disclosure can be combined with each other to form a combined embodiment, which will not be repeated in the present disclosure due to limited space. Those skilled in the art can understand that, in the foregoing methods of the detailed description, the specific execution order of the steps should be determined by functions and possible internal logics of the steps.

In addition, the present disclosure further provides a category labelling apparatus, an electronic device, a computer readable storage medium, and a program, all of which can be used to implement any category labelling method provided in the present disclosure. For the corresponding technical solutions and descriptions, refer to the corresponding records in the method section, and details are not repeated again.

FIG. 2 shows a block diagram of a category labelling apparatus 20 according to an embodiment of the present disclosure. As shown in FIG. 2, the category labelling apparatus 20 includes:

a detection result determining module 21, configured to detect a video stream acquired by an image acquisition device to determine a detection result of a target video frame in the video stream, where the detection result includes a detected category, and the detected category includes at least one of an object category of an object in the target video frame, and a scene category corresponding to the target video frame; and

a labelling result determining module 22, configured to determine a category labelling result corresponding to the image acquisition device according to detection results of a plurality of target video frames.

In a possible implementation, the detection result determining module 21 is configured to determine a confidence of each of a plurality of categories corresponding to the target video frame; and in a case that there is a confidence greater than a confidence threshold, determining a category having the confidence greater than the confidence threshold as the detection result of the target video frame.

In a possible implementation, the apparatus further includes: a total number determining module, configured to determine a total number of the detection results obtained in a preset time interval; and the labelling result determining module 22, configured to: in response to the total number of the detection results being greater than a number threshold, determine the category labelling result corresponding to the image acquisition device according to the detection results of the plurality of target video frames.

In a possible implementation, there are a plurality of detection results, and the labelling result determining module 22 includes a first labelling result determining submodule and a second labelling result determining submodule, where the first labelling result determining submodule is configured to determine a ratio of a number of one or more detection categories in the plurality of detection results to the total number; and the second labelling result determining submodule is configured to determine a detected category corresponding to a ratio greater than a ratio threshold as the category labelling result corresponding to the image acquisition device.

In a possible implementation, the object category includes at least one of: a face, a human body, a license plate, or a vehicle model; and the scene category includes at least one of: high altitude, low-altitude indoor, or low-altitude outdoor.

In a possible implementation, the apparatus further includes: a search module, configured to: in response to receiving a search request for a target image acquisition device of a target category, return the target image acquisition device of the target category based on the determined category labelling result corresponding to the image acquisition device.

In a possible implementation, the apparatus further includes: a time determining module, configured to determine whether current time is night time; and the detection result determining module 21, configured to: in response to determining that the current time is not night time, detect the video stream acquired by the image acquisition device.

In the embodiments of the present disclosure, the category labelling result of the image acquisition device can be accurately determined, to implement category division on the image acquisition device, to facilitate an administrator in managing and calling the image acquisition device in the dimension of the category, thereby reducing the difficulty in managing the image acquisition device.

In some embodiments, the functions of modules included in the apparatus provided in the embodiments of the present disclosure may be used to perform the methods described in the foregoing method embodiments. For brevity, details are not repeated herein.

An embodiment of the present disclosure further provides a computer readable storage medium having computer program instructions stored thereon, which, when executed by a processor, implement the foregoing method. The computer readable storage medium may be a non-volatile computer readable storage medium.

An embodiment of the present disclosure further provides an electronic device, including a processor; and a memory, configured to store processor executable instructions, where the processor is configured to execute the instructions stored in the memory, to perform the foregoing method.

An embodiment of the present disclosure further provides a computer program product, including computer readable code, where when the computer readable code runs on a device, a processor in the device is configured to implement an instruction of the category labelling method according to any one of the foregoing embodiments.

An embodiment of the present disclosure further provides another computer program product, used for storing computer readable instructions, where when the instructions are executed, the computer is enabled to perform an operation of the category labelling method according to any one of the foregoing embodiments.

The electronic device may be provided as a terminal, a server, or a device of another form.

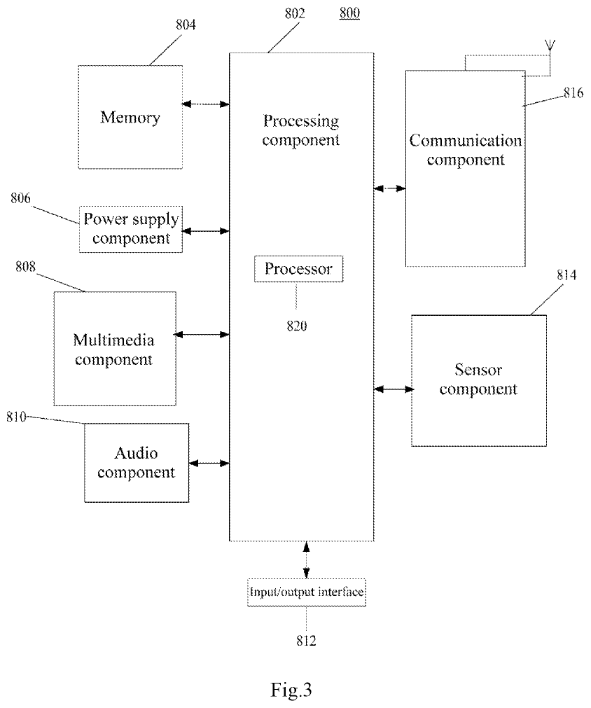

FIG. 3 is a block diagram of an electronic device 800 according to an embodiment of the present disclosure. For example, the electronic device 800 may be a mobile phone, a computer, a digital broadcast terminal, a message transceiver, a game console, a tablet device, a medical device, a fitness facility, a personal digital assistant, or any other terminal.

Referring to FIG. 3, the electronic device 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the electronic device 800, such as operations associated with display, phone call, data communication, camera operation, and record operation. The processing component 802 may include one or more processors 820 to execute instructions, to complete all or some steps of the foregoing method. In addition, the processing component 802 may include one or more modules, to facilitate the interaction between the processing component 802 and other components. For example, the processing component 802 may include a multimedia module, to facilitate the interaction between the multimedia component 808 and the processing component 802.

The memory 804 is configured to store various types of data to support the operations of the electronic device 800. Examples of the data include instructions for any application or method for operation on the electronic device 800, contact data, address book data, messages, pictures, videos, etc. The memory 804 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disc, or a compact disc.

The power supply component 806 provides power for the components of the electronic device 800. The power supply component 806 may include a power supply management system, one or more power supplies, and other components related to generation, management, and allocation of power for the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense a touch, a slide, and a gesture on the touch panel. The touch sensor may not only sense a perimeter of the touch or slide act, but also detect duration and pressure related to the touch or slide operation. In some embodiments, the multimedia component 808 includes a front camera and/or a rear camera. When the electronic device 800 is in an operation mode, such as a shoot mode or a video mode, the front camera and/or the rear camera may receive external multimedia data. Each front camera and rear camera may be a fixed optical lens system or have a focal length and an optical zooming capability.

The audio component 810 is configured to output and/or input an audio signal. For example, the audio component 810 includes a microphone (MIC). When the electronic device 800 is in the operation mode, such as a call mode, a record mode, and a voice recognition mode, the microphone is configured to receive an external audio signal. The received audio signal may be further stored in the memory 804 or sent through the communication component 816. In some embodiments, the audio component 810 further includes a loudspeaker, which is configured to output an audio signal.

The I/O interface 812 provides an interface between the processing component 802 and a peripheral interface module. The peripheral interface module may be a keyboard, a click wheel, buttons, or the like. The buttons may include, but not limited to: a home button, a volume button, a start-up button, and a lock button.

The sensor component 814 includes one or more sensors, which are configured to provide the electronic device 800 with various aspects of state assessment. For example, the sensor component 814 may detect an open/closed state of the electronic device 800, and relative positioning of the component. For example, the component is a display and a small keyboard of the electronic device 800. The sensor component 814 may also detect the position change of the electronic device 800 or one component of the electronic device 800, the existence or nonexistence of contact between the user and the electronic device 800, the directions or acceleration/deceleration of the electronic device 800, and the temperature change of the electronic device 800. The sensor component 814 may include a proximity sensor, configured to detect the existence of nearby objects without any physical contact. The sensor component 814 may further include an optical sensor, such as a CMOS or CCD image sensor, which is used in an imaging application. In some embodiments, the sensor component 814 may further include an acceleration sensor, a gyroscope sensor, a magnetic sensor, a pressure sensor, or a temperature sensor.

The communication component 816 is configured to facilitate communication between the electronic device 800 and other devices in a wired or wireless manner. The electronic device 800 may access a wireless network based on communication standards, such as WiFi, 2G, 3G, or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module, to promote short range communication. For example, the NFC module may be implemented based on a radio frequency identification (RFID) technology, an infra-red data association (IrDA) technology, an ultra-wideband (UWB) technology, a Bluetooth (BT) technology, and other technologies.

In an exemplary embodiment, the electronic device 800 may be implemented by using one or more application-specific integrated circuits (ASIC), a digital signal processor (DSP), a digital signal processing device (DSPD), a programmable logic device (PLD), a field programmable gate array (FPGA), a controller, a micro-controller, a microprocessor or other electronic elements, to perform the foregoing method.

In an exemplary embodiment, there is further provided a non-volatile computer readable storage medium, for example, a memory 804 that includes computer program instructions. The computer program instructions may be executed by a processor 820 of the electronic device 800 to perform the foregoing method.

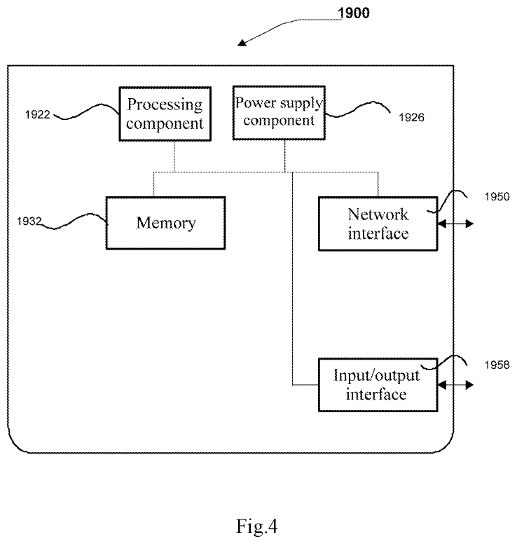

FIG. 4 is a block diagram of an electronic device 1900 according to an embodiment of the present disclosure. For example, the electronic device 1900 may be provided as a server. Referring to FIG. 4, the electronic device 1900 includes: a processing component 1922, the processing component 1922 further including one or more processors, and a memory resource represented by a memory 1932, the memory resource being used for storing instructions, for example, an application, that can be executed by the processing component 1922. The application stored in the memory 1932 may include one or more modules, each of which corresponds to a set of instructions. In addition, the processing component 1922 is configured to execute instructions, to perform the foregoing method.

The electronic device 1900 may further include: a power supply component 1926, configured to manage power supply of the electronic device 1900, a wired or wireless network interface 1950, configured to connect the electronic device 1900 to a network, and an input/output (I/O) interface 1958. The electronic device 1900 may run an operating system stored in the memory 1932, such as Windows Server™, Mac OS X™, Unix™, Linux™, FreeBSD™, or the like.

In an exemplary embodiment, there is further provided a non-volatile computer readable storage medium, for example, a memory 1932 that includes computer program instructions. The computer program instructions may be executed by the processing component 1922 of the electronic device 1900, to complete the foregoing method.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium can be a tangible device that can retain and store instructions used by an instruction executing device. The computer readable storage medium may be, but not limited to, e.g., electrical storage device, magnetic storage device, optical storage device, electromagnetic storage device, semiconductor storage device, or any proper combination thereof. An non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disk read-only memory (CD-ROM), digital versatile disk (DVD), memory stick, floppy disk, mechanical encoded device (for example, punch-cards or raised structures in a groove having instructions stored thereon, and any proper combination thereof. A computer readable storage medium referred herein should not be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or external storage device via network, for example, the Internet, local area network, wide area network and/or wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In a scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve the aspects of the present disclosure.

Aspects of the present disclosure have been described herein with reference to the flowchart and/or the block diagrams of method, device (systems), and computer program product according to the embodiments of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein comprises a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a part of code, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be performed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions.

The computer program product may be specifically implemented by hardware, software or a combination thereof. In an optional embodiment, the computer program product is specifically embodied as a computer storage medium. In another optional embodiment, the computer program product is specifically embodied as a software product, such as a software development kit (SDK), or the like.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A category labelling method, comprising:
detecting a video stream acquired by an image acquisition device to determine a detection result of a target video frame in the video stream, wherein the detection result includes a detected category, and the detected category includes at least one of: an object category of an object in the target video frame, and a scene category corresponding to the target video frame; and
determining a category labelling result corresponding to the image acquisition device according to detection results of a plurality of target video frames.

2. The method according to claim 1, wherein detecting the video stream acquired by the image acquisition device to determine the detection result of the target video frame in the video stream includes:
determining a confidence of each of a plurality of categories corresponding to the target video frame; and
in a case that there is a confidence greater than a confidence threshold, determining a category having the confidence greater than the confidence threshold as the detection result of the target video frame.

3. The method according to claim 1, wherein after determining the detection result of the target video frame in the video stream, the method further comprises:
determining a total number of the detection results obtained in a preset time interval; and
determining the category labelling result corresponding to the image acquisition device according to the detection results of the plurality of target video frames includes:
in response to the total number of the detection results being greater than a number threshold, determining the category labelling result corresponding to the image acquisition device according to the detection results of the plurality of target video frames.

4. The method according to claim 3, wherein there are a plurality of the detection results, and determining the category labelling result corresponding to the image acquisition device according to the detection results of the plurality of target video frames includes:
determining a ratio of a number of one or more detection categories in the plurality of detection results to the total number; and
determining the detected category corresponding to the ratio greater than a ratio threshold as the category labelling result corresponding to the image acquisition device.

5. The method according to claim 1, wherein the object category includes at least one of: a face, a human body, a license plate, or a vehicle model; and
the scene category includes at least one of: high altitude, low-altitude indoor, or low-altitude outdoor.

6. The method according to claim 1, wherein after determining the category labelling result corresponding to the image acquisition device, the method further comprises:
in response to receiving a search request for a target image acquisition device of a target category, returning the target image acquisition device of the target category based on the determined category labelling result corresponding to the image acquisition device.

7. The method according to claim 1, wherein before detecting the video stream acquired by the image acquisition device, the method further comprises:
determining whether current time is night time; and
detecting the video stream acquired by the image acquisition device includes:
in response to determining that the current time is not night time, detecting the video stream acquired by the image acquisition device.

8. A category labelling device, comprising:
a processor; and
a memory, configured to store processor executable instructions,
wherein the processor is configured to execute instructions stored by the memory, so as to:
detect a video stream acquired by an image acquisition device to determine a detection result of a target video frame in the video stream, wherein the detection result includes a detected category, and the detected category includes at least one of: an object category of an object in the target video frame, and a scene category corresponding to the target video frame; and
determine a category labelling result corresponding to the image acquisition device according to detection results of a plurality of target video frames.

9. The category labelling device according to claim 8, wherein detecting the video stream acquired by the image acquisition device to determine the detection result of the target video frame in the video stream includes:
determining a confidence of each of a plurality of categories corresponding to the target video frame; and
in a case that there is a confidence greater than a confidence threshold, determining a category having the confidence greater than the confidence threshold as the detection result of the target video frame.

10. The category labelling device according to claim 8, wherein after determining the detection result of the target video frame in the video stream, the processor is further configured to:
determine a total number of the detection results obtained in a preset time interval; and
determine the category labelling result corresponding to the image acquisition device according to the detection results of the plurality of target video frames includes:
in response to the total number of the detection results being greater than a number threshold, determine the category labelling result corresponding to the image acquisition device according to the detection results of the plurality of target video frames.

11. The category labelling device according to claim 10, wherein there are a plurality of the detection results, and determining the category labelling result corresponding to the image acquisition device according to the detection results of the plurality of target video frames includes:
determining a ratio of a number of one or more detection categories in the plurality of detection results to the total number; and
determining the detected category corresponding to the ratio greater than a ratio threshold as the category labelling result corresponding to the image acquisition device.

12. The category labelling device according to claim 8, wherein the object category includes at least one of: a face, a human body, a license plate, or a vehicle model; and
the scene category includes at least one of: high altitude, low-altitude indoor, or low-altitude outdoor.

13. The category labelling device according to claim 8, wherein after determining the category labelling result corresponding to the image acquisition device, the processor is further configured to:
in response to receiving a search request for a target image acquisition device of a target category, return the target image acquisition device of the target category based on the determined category labelling result corresponding to the image acquisition device.

14. The category labelling device according to claim 8, wherein before detecting the video stream acquired by the image acquisition device, the processor is further configured to:
determine whether current time is night time; and
detect the video stream acquired by the image acquisition device includes:
in response to determining that the current time is not night time, detect the video stream acquired by the image acquisition device.

15. A non-transitory computer readable storage medium, having computer program instructions stored thereon, the computer program instructions, when executed by a processor, cause the processor to implement operations comprising:
detecting a video stream acquired by an image acquisition device to determine a detection result of a target video frame in the video stream, wherein the detection result includes a detected category, and the detected category includes at least one of: an object category of an object in the target video frame, and a scene category corresponding to the target video frame; and
determining a category labelling result corresponding to the image acquisition device according to detection results of a plurality of target video frames.

16. The non-transitory computer readable storage medium according to claim 15, wherein detecting the video stream acquired by the image acquisition device to determine the detection result of the target video frame in the video stream includes:
determining a confidence of each of a plurality of categories corresponding to the target video frame; and
in a case that there is a confidence greater than a confidence threshold, determining a category having the confidence greater than the confidence threshold as the detection result of the target video frame.

17. The non-transitory computer readable storage medium according to claim 15, wherein after determining the detection result of the target video frame in the video stream, the method further comprises:
determining a total number of the detection results obtained in a preset time interval; and
determining the category labelling result corresponding to the image acquisition device according to the detection results of the plurality of target video frames includes:
in response to the total number of the detection results being greater than a number threshold, determining the category labelling result corresponding to the image acquisition device according to the detection results of the plurality of target video frames.

18. The non-transitory computer readable storage medium according to claim 15, wherein there are a plurality of the detection results, and determining the category labelling result corresponding to the image acquisition device according to the detection results of the plurality of target video frames includes:
determining a ratio of a number of one or more detection categories in the plurality of detection results to the total number; and
determining the detected category corresponding to the ratio greater than a ratio threshold as the category labelling result corresponding to the image acquisition device.

19. The non-transitory computer readable storage medium according to claim 15, wherein after determining the category labelling result corresponding to the image acquisition device, the method further comprises:
in response to receiving a search request for a target image acquisition device of a target category, returning the target image acquisition device of the target category based on the determined category labelling result corresponding to the image acquisition device.

20. The non-transitory computer readable storage medium according to claim 15, wherein before detecting the video stream acquired by the image acquisition device, the method further comprises:
determining whether current time is night time; and
detecting the video stream acquired by the image acquisition device includes:
in response to determining that the current time is not night time, detecting the video stream acquired by the image acquisition device.
